(19) United States
(12) Patent Application Publication
(10) Pub. No.: US 2021/0334236 A1
(43) Pub. Date: Oct. 28, 2021

(54) SUPPORTING DISTRIBUTED AND LOCAL OBJECTS USING A MULTI-WRITER LOG-STRUCTURED FILE SYSTEM

(71) Applicant: VMware, Inc., Palo Alto, CA (US)

(72) Inventors: Wenguang Wang, Santa Clara, CA (US); Vamsi Gunturu, Cupertino, CA (US)

(21) Appl. No.: 16/857,517

(22) Filed: Apr. 24, 2020

(51) Int. Cl. G06F 16/11; G06F 16/182; G06F 12/10

(52) U.S. Cl. CPC G06F 16/11; G06F 12/10; G06F 16/182

(57) ABSTRACT

Supporting distributed and local objects using a multi-writer log-structured file system (LFS) includes, on a node, receiving incoming data from each of a plurality of local objects; coalescing the received data; determining whether the coalesced data comprises a full segment of data; based at least on the coalesced incoming data comprises a full segment, writing at least a first portion of the coalesced data to a first storage of the LFS, wherein the coalesced data comprises the first portion and a remainder portion; writing the remainder portion to a second storage of the LFS; acknowledging the writing to the objects; determining whether at least a full segment of data has accumulated in the second storage; based at least on determining that at least a full segment has accumulated, writing at least a portion of the accumulated data as one or more full segments of data to the first storage.

### BACKGROUND

In some distributed computing arrangements, servers may attach a large number of storage devices (e.g., flash, solid state drives (SSDs), non-volatile memory express (NVMe), Persistent Memory (PMEM)) and may use a log-structured file system (LFS). During data writes to storage devices, a phenomenon termed write amplification may occur, in which more data is actually written to the physical media than was sent for writing in the input/output (I/O) event. Write amplification is an inefficiency that produces unfavorable I/O delays, and may arise as a result of parity blocks that are used for error detection and correction (among other reasons). In general, the inefficiency may depend somewhat on the amount of data being written.

In a distributed block storage system, there are multiple objects on each node, although the outstanding I/O (OIO) may be small for each object. When an erasure coding policy is used, low OIO can amplify the writes significantly. For example, if there are 100 virtual machine (VM) objects per node, each writing out to a 4+2 RAID-6 (redundant array of independent disks), each write will be amplified to a 3× write to the data log on the performance tier first. This results in 300 block writes, rather than the 100 original writes intended. Without a fast performance tier, the write amplification may create a problematic bottleneck.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Solutions for supporting distributed and local objects using a multi-writer LFS include, on a node, receiving incoming data from each of a plurality of local objects; coalescing the received data; determining whether the coalesced data comprises a full segment of data; based at least on the coalesced incoming data comprises a full segment, writing at least a first portion of the coalesced data a full segment of data to a first storage of the multi-writer LFS, wherein the coalesced data comprises the first portion and a remainder portion; writing the remainder portion to a second storage; acknowledging the writing to the plurality of objects; determining whether at least a full segment of data has accumulated in the second storage; based at least on determining that at least a full segment has accumulated in the second storage, writing at least a portion of the accumulated data as one or more full segments of data to the first storage.

### BRIEF DESCRIPTION OF THE DRAWINGS

The present description will be better understood from the following detailed description read in the light of the accompanying drawings, wherein:

FIG. 1 illustrates an architecture that can advantageously support objects on distributed storage;

FIG. 2 illustrates additional details for the architecture of FIG. 1;

FIGS. 3A and 3B illustrate further details for various components of FIGS. 1 and 2;

FIGS. 3C and 3D illustrate exemplary messaging among various components of FIGS. 1 and 2;

FIG. 4 illustrates a flow chart of exemplary operations associated with the architecture of FIG. 1;

FIG. 5 illustrates a flow chart of additional exemplary operations that may be used in conjunction with the flow chart of FIG. 4;

FIG. 6 illustrates another flow chart of additional exemplary operations that may be used in conjunction with the flow chart of FIG. 4;

FIG. 7 illustrates another flow chart of exemplary operations associated with the architecture of FIG. 1; and

FIG. 8 illustrates a block diagram of a computing device that may be used as a component of the architecture of FIG. 1, according to an example embodiment.

### DETAILED DESCRIPTION

Virtualization software that provides software-defined storage (SDS), by pooling storage across a cluster, creates a distributed, shared data store, for example a storage area network (SAN). A log-structured file system (LFS) takes advantage of larger memory sizes that lead to write-heavy input/output (I/O) by writing data and metadata to a circular buffer, called a log. Combining a SAN with an LFS, and making the SAN a single global object, permits the creation of a multi-writer LFS, which may be written to concurrently from objects (e.g., virtual machines (VMs)) on multiple compute nodes. The result is a multi-writer LFS, as disclosed herein.

Aspects of the disclosure improve the speed of computer storage (e.g., speeding data writing) with a multi-writer LFS by coalescing data from multiple objects and, based at least on determining that the coalesced data comprises at least a full segment of data, writing at least a first portion as one or more full segments to a first storage. This avoids writing at least the first portion to a mirrored log, writing only a remainder, if necessary. Aspects of the disclosure thus reduce write amplification by coalescing (aggregating) writes from multiple different objects on the same node. In some examples, write amplification may be reduced by half or more and thereby relax the need for a fast performance tier. Multiple processes are implemented, including (1) allowing local objects without any fault tolerance, and (2) adding per-node segment cleaning (garbage collection) threads that consolidate segments only on their own nodes.

In some examples, a physical host node may support 50 to 100 objects or more, so there is a likelihood that data from more than a single object needs to be written at any given time, and that the aggregation of the writes may fill an entire segment. When in-flight I/O (outstanding I/O, OIO) is able to fill an free segment, it may be written to the capacity tier without a need to first go to the log. For example, with 512 kilobytes (KB) of in-flight I/O and 512 KB segments, the in-flight I/O may be written immediately, avoiding a detour through the log. This improves the efficiency of computer operations, and makes better use of computing resources (e.g., storage, processing, and network bandwidth).

Some examples use a multi-writer LFS, in which different objects (e.g., VMs) do not manage their own writes. In the above example of 100 objects each writing a single block, by coalescing the writes, only 150 blocks (rather than 300) are written with a RAID-6 (redundant array of independent disks) architecture, with 50 of the blocks being parity blocks. This is a reduction from 3× amplification to 1.5× amplification. The performance tier requirements may thus be relaxed because full segment (e.g. full stripe) writes go straight to the capacity tier and are not written to the performance tier. Only an amount beyond a full segment (or if the coalesced writes are less than a full segment) is written to the performance tier. This reduces the amount of data subjected to 3-way mirroring (or other number of mirrors that match the same kind of fault tolerance as the capacity tier protected by erasure coding).

In some examples, local objects support Shared Nothing (SN) architecture, a distributed-computing architecture in which each update request is satisfied by a single node (processor/memory/storage unit). This may reduce contention among nodes by avoiding the sharing of memory and storage among the local-only nodes. In some examples, nodes have their own local storage, which cannot tolerate the node failure. Local storage may often be considerably faster than RAID-6, due to the lack of network delays. In some examples, segment cleaning is local, using a segment cleaner running on each node. Each cleaner owns a shard of the segments and performs segment cleaning work by reading live data from the segment it manages and writes out the live data using the regular write path.

Some aspects of the disclosure additionally leverage existing virtualization software, thereby increasing the efficiency of computing operations, by using segment usage tables (SUTs). SUTs are used to track the space usage of storage segments. In general, storage devices are organized into full stripes spanning multiple nodes and each full stripe may be termed a segment. In some examples, a segment comprises an integer number of stripes. Multiple SUTs are used: local SUTs and a master SUT that is managed by a master SUT owner (e.g., the owner of the master SUT). Local SUTs track writer I/Os, and changes are merged into the master SUT. Aspects of the disclosure update a local SUT to mark segments as no longer free, and merge local SUT updates into the master SUT. By aggregating all of the updates, the master SUT is able to allocate free segments to the writers (e.g., processes executing on the nodes). Each compute node may have one or more writers, but since the master SUT allocates different free segments to different writers, the writers may operate in parallel without colliding. Different writers do not write to overlapping contents or ranges. In some examples, the master SUT owner partitions segments as local or global segments. This allows a node to have both a local storage object and global storage segments. Different nodes share free space, which is managed by the master SUT owner.

In some examples, upon accumulating a full segment worth of data in the log, a full segment write is issued in an erasure-encoded manner. This process further mitigates write amplification. In some examples, when an object (e.g., a writer or a virtual machine disk (VMDK)) moves from one compute node to another compute node, it first replays its part of the data log from its original compute node to reconstruct the mapping table state on the new compute node before accepting new I/Os. In some examples, a logical-to-physical map (e.g., addressing table) uses the object identifier (ID) (e.g., the ID of the object or Virtual Machine Disk (VMDK)) as the major key so that each object's map does not overlap with another object's map. In some examples, the object maps are represented as B-trees or Write-Optimized Trees and are protected by the metadata written out together with the log. In some examples, the metadata is stored in the performance tier with 3-way mirror and is not managed by the multi-writer LFS.

Solutions for supporting distributed and local objects using a multi-writer LFS include, on a node, receiving incoming data from each of a plurality of local objects; coalescing the received data; determining whether the coalesced data comprises a full segment of data; based at least on the coalesced incoming data comprises a full segment, writing at least a first portion of the coalesced data a full segment of data to a first storage of the multi-writer LFS, wherein the coalesced data comprises the first portion and a remainder portion; writing the remainder portion to a second storage; acknowledging the writing to the plurality of objects; determining whether at least a full segment of data has accumulated in the second storage; based at least on determining that at least a full segment has accumulated in the second storage, writing at least a portion of the accumulated data as one or more full segments of data to the first storage.

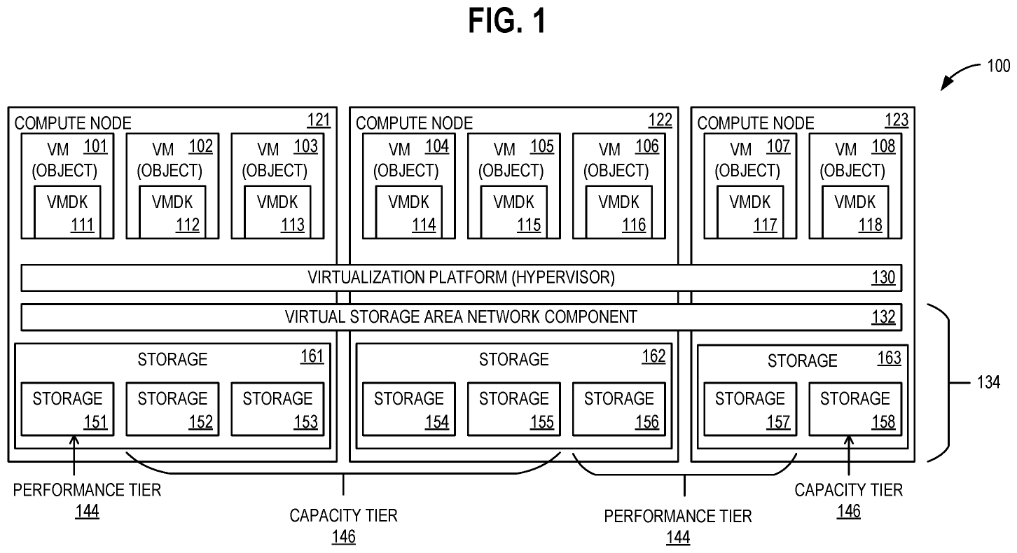

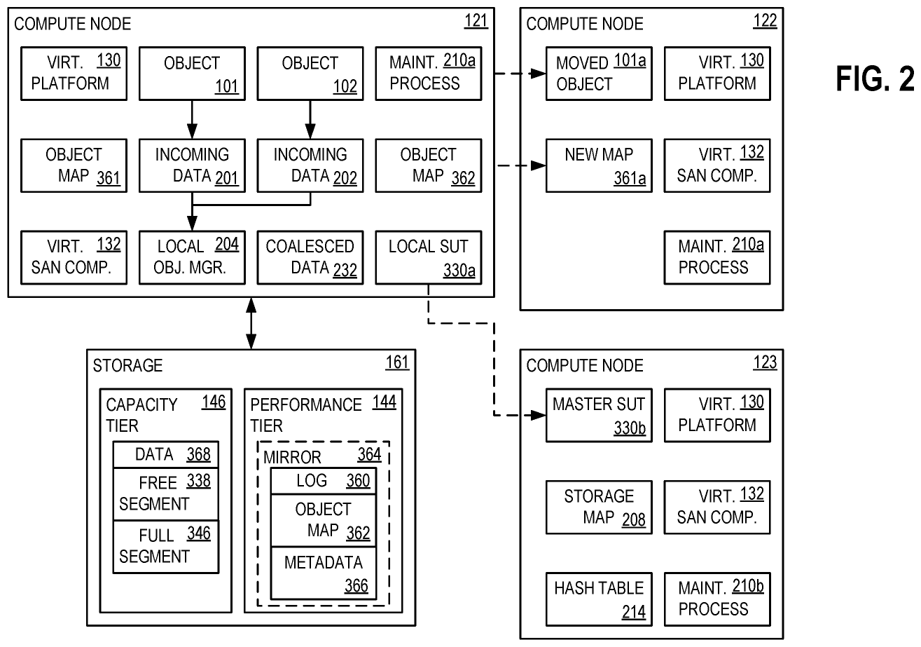

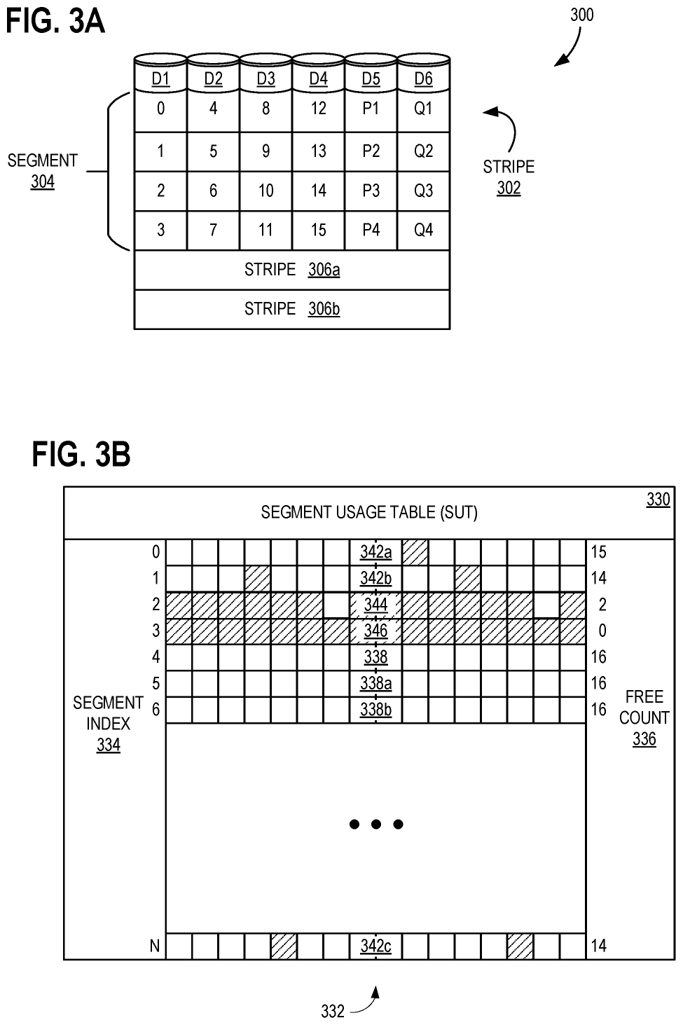

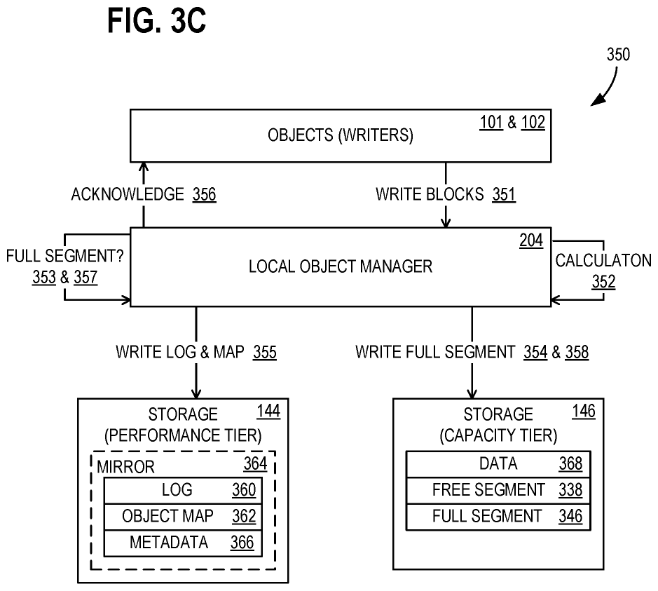

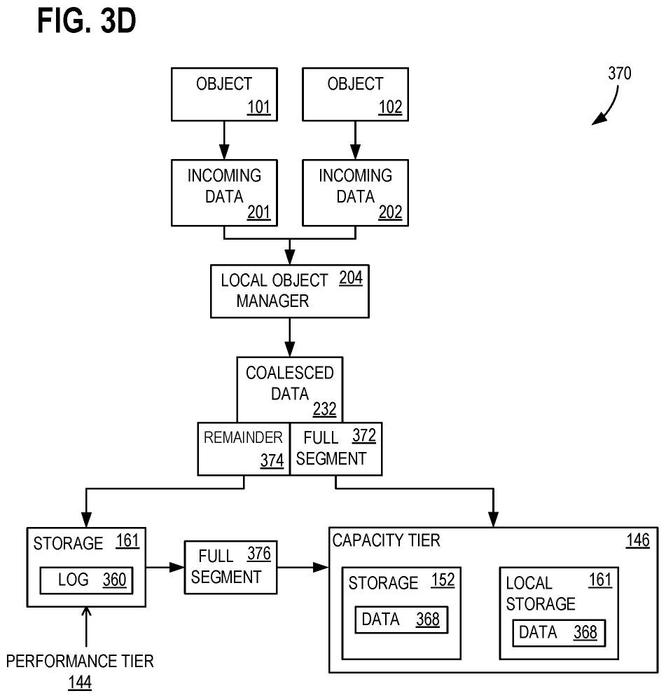

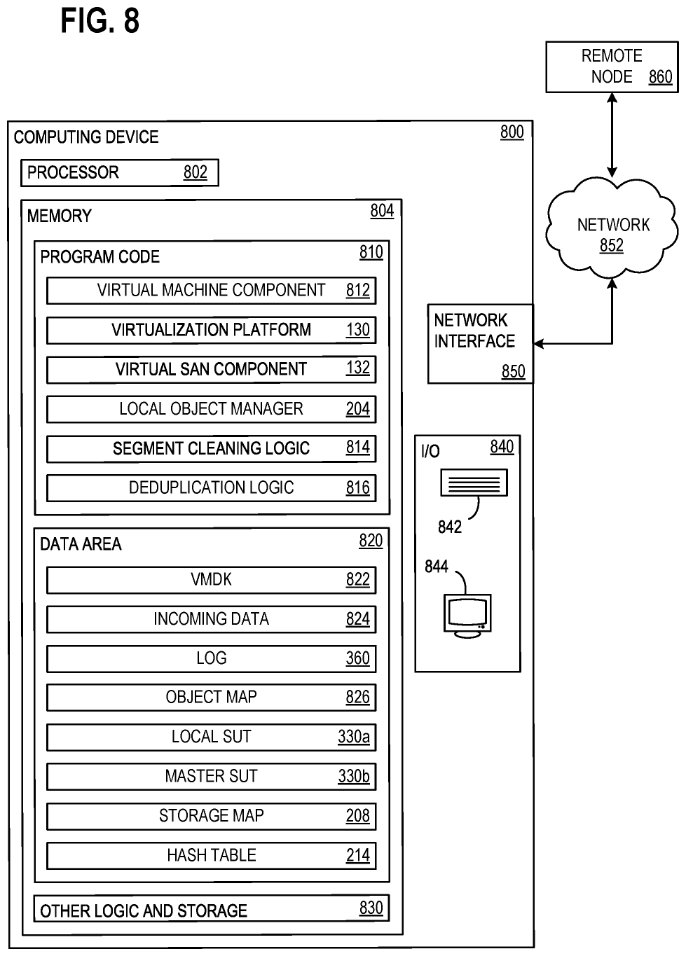

FIG. 1 illustrates an architecture 100 that can advantageously support distributed and local objects on distributed storage. Additional details of architecture 100 are provided in FIGS. 2-3B, some exemplary data flows within architecture 100 are illustrated in FIGS. 3C and 3D, and operations associated with architecture 100 are illustrated in flow charts of FIGS. 4-7. The components of architecture 100 will be briefly described in relation to FIGS. 1-3B, and their operations will be described in further detail in relation to FIGS. 3C-7. In some examples, various components of architecture 100, for example compute nodes 121, 122, and 123 are implemented using one or more computing devices 800 of FIG. 8.

Architecture 100 is comprised of a set of compute nodes 121-123 interconnected with each other, although a different number of compute nodes may be used. Each compute node hosts multiple objects, which may be VMs, containers, applications, or any compute entity that can consume storage. When objects are created, they are designated as global or local, and the designation is stored in an attribute. For example, compute node 121 hosts objects 101, 102, and 103; compute node 122 hosts objects 104, 105, and 106; and compute node 123 hosts objects 107 and 108. Some of objects 101-108 are local objects. In some examples, a single compute node may host 50, 100, or a different number of objects. Each object uses a VMDK, for example VMDKs 111-118 for each of objects 101-108, respectively. Other implementations using different formats are also possible. A virtualization platform 130, which includes hypervisor functionality at one or more of computer nodes 121, 122, and 123, manages objects 101-108.

Compute nodes 121-123 each include multiple physical storage components, which may include flash, solid state drives (SSDs), non-volatile memory express (NVMe), persistent memory (PMEM), and quad-level cell (QLC) storage solutions. For example, compute node 121 has storage 151, 152, and 153 locally; compute node 122 has storage 154, 155, and 156 locally; and compute node 123 has storage 157 and 158 locally. In some examples a single compute node may include a different number of physical storage components. In the described examples, compute nodes 121-123 operate as a SAN with a single global object, enabling any of objects 101-108 to write to and read from any of storage 151-158 using a virtual SAN component 132. Virtual SAN component 132 executes in compute nodes 121-123. Virtual SAN component 132 and storage 151-158 together form a multi-writer LFS 134. Because multiple ones of objects 101-108 are able to write to multi-writer LFS 134 simultaneously, multi-writer LFS 134 is hence termed global or multi-writer. Simultaneous writes are possible, without collisions (conflicts), because each object (writer) uses its own local SUT that was assigned its own set of free spaces.

In general, storage components may be categorized as performance tier or capacity tier. Performance tier storage is generally faster, at least for writing, than capacity tier storage. In some examples, performance tier storage has a latency approximately 10% that of capacity tier storage. Thus, when speed is important, and the amount of data is relatively small, write operations will be directed to performance tier storage. However, when the amount of data to be written is larger, capacity tier storage will be used. As illustrated, storage 151 is designated as a performance tier 144 and storage 152-158 is designated as a capacity tier 146. In general, metadata is written to performance tier 144 and bulk object data is written to capacity tier 146. In some scenarios, as explained below, data intended for capacity tier 146 is temporarily stored on performance tier 144, until a sufficient amount has accumulated such that writing operations to capacity tier 146 will be more efficient (e.g., by reducing write amplification).

As illustrated, compute nodes 121-123 each have their own storage. For example, compute node 121 has storage 161, compute node 122 has storage 162, and compute node 123 has storage 16. Storage 161-163 are generally faster for local storage operations than for network storage operations, due to the lack of network delays and parity. In general, storage 161-163 may be considered to be part of capacity tier 146.

FIG. 2 illustrates additional details for the architecture of FIG. 1. Compute nodes 121-123 each include a manifestation of virtualization platform 130 and virtual SAN component 132. Virtualization platform 130 manages the generating, operations, and clean-up of objects 101 and 102, including the moving of object 101 from compute node 121 to compute node 121, to become moved object 101a. Virtual SAN component 132 permits objects 101 and 102 to write incoming data 201 (incoming from object 101) and incoming data 202 (incoming from object 102) to capacity tier 146 and performance tier 144, in part, by virtualizing the physical storage components of storage 161-163. Storage 161-163 are described in further detail in relation to FIG. 3A.

Turning briefly to FIG. 3A, a set of disks D1, D2, D3, D4, D5, and D6 are shown in a data striping arrangement 300. Data striping segments logically sequential data, such as blocks of files, so that consecutive portions are stored on different physical storage devices. By spreading portions across multiple devices which can be accessed concurrently, total data throughput is increased. This also balances I/O load across an array of disks. Striping is used across disk drives in redundant array of independent disks (RAID) storage, for example RAID-5/6. RAID configurations may employ the techniques of striping, mirroring, or parity to create large reliable data stores from multiple general-purpose storage devices. RAID-5 consists of block-level striping with distributed parity. Upon failure of a single storage device, subsequent reads can be calculated using the distributed parity as an error correction attempt. RAID 6 extends RAID 5 by adding a second parity block. Arrangement 300 may thus be viewed as a RAID-6 arrangement with four data disks (D1-D4) and two parity disks (D5 and D6). This is a 4+2 configuration. Other configurations are possible, such as 17+3, 20+2, 12+4, 15+7, and 100+2.

A stripe is a rectangle set of blocks, as shown in FIG. 3, for example as stripe 302. Four columns are data blocks, based on the number of data disks, D1-D4, and two of the columns are parities, indicated as P1 and Q1 in the first row, based on the number of parity disks, D5 and D6. Thus, in some examples, the stripe size is defined by the available storage size. In some examples, blocks are each 4 KB. In some examples, QLC requires a 128 KB write. With 128 KB and six disks, the stripe size is 768 KB (128 KB×6=768 KB), of which 512 KB is data, and 256 KB is parity. With 32 disks, the stripe size is 4 megabytes (MB). A segment 304 is shown as including 4 blocks from each of D1-D4, numbered 0 through 15, plus parity blocks designated with P1-P4 and Q1-Q4. A segment is the unit of segment cleaning, and in some examples, is aligned on stripe boundaries. In some examples, a segment is a stripe. In some examples, a segment is an integer number of stripes. Additional stripes 306a and 306b are shown below segment 304.

When a block is being written, write amplification occurs. In general, there are three types of updates: small partial stripe writes, large partial stripe writes, and full stripe writes. With small partial stripe writes, old content of the to-be-written blocks and parity blocks are read to calculate the new parity blocks, and new blocks and parity blocks are written. With large partial stripe writes, the untouched blocks in the stripe of the content are read to calculate the new parity blocks, and new blocks and new parity blocks are written. With full stripe writes, new parity blocks are calculated based on new blocks, and the full stripe is written. When writing only full stripes or segments, the read-modify-write penalty can be avoided, reducing write amplification and increasing efficiency and speed.

Returning now to FIG. 2, in some examples, a local object manager 204 receives and coalesces incoming data 201 from object 101 and incoming data 202 from object 102 (plus from other writers), and coalesces them into coalesced incoming data 232. Local object manager 204 treats the virtualization layer of virtual SAN component 132 as a physical layer, in some examples (e.g., by adding its own logical-to-physical map, checksum, caching, and free space management, onto it and exposing its logical address space). In some examples, local object manager 204 manages the updating of local SUT 330a on compute node 121. Either local object manager 204 or virtual SAN component 132 (or another component) manages merging updates to local SUT 330a into master SUT 330b on compute node 123. Compute node 123 is the owner of master SUT 330b, that is, compute node 123 is the master SUT owner. Both compute nodes 122 and 123 may also have their own local SUTs, and changes to those local SUTs will also be merged into master SUT 330b. Because each object (e.g., VM, deduplication process, segment cleaning process, or another writer) goes through its own version of local SUT 330a, which is allocated its own free space according to master SUT 330b, there will be no conflicts. Local SUT 330a and master SUT 330b are described in further detail in relation to FIG. 3B.

Turning briefly to FIG. 3B, an exemplary SUT 330 is illustrated. SUT 330 may represent either local SUT 330a or master SUT 330b. SUT 330 is used to track the space usage of each segment in a storage arrangement, such as arrangement 300. In some examples, SUT 330 is pulled from storage (e.g., storage 161) during bootstrap, into the hypervisor functionality of virtualization platform 130. In FIG. 3B, segments are illustrated as rows of matrix 332, and blocks with live data (live blocks) are indicated with shading). Each segment has an index, indicated in segment index column 334. The number of blocks available for writing are indicated in free count column 336. The number of blocks available for writing decrements with each write operation. For example, a free segment, such as free segment 338, has a free count equal to the total number of blocks in the segment (in the illustrated example, 16), whereas a full segment, such as full segment 346 has a free count of zero. In some examples, a live block count is used, in which a value of zero indicates a free segment rather than a full segment. In some examples, SUT 330 forms a doubly-linked list. A doubly linked list is a linked data structure that consists of a set of sequentially linked records.

SUT 330 is used to keep track of space usage and age in each segment. This is needed for segment cleaning, and also to identify free segments, such as free segments 338, 338a, and 338b, to allocate to individual writers (e.g., objects 101-108, deduplication processes, and segment cleaning processes). If a free count indicates that no blocks in a segment contain live data, that block can be written to without any need to move any blocks. Any prior-written data in that segment has either already been moved or marked as deleted and thus may be over-written without penalty. This avoids read operations that would be needed if data in that segment needed to be moved elsewhere for preservation.

As indicated, segments 342a, 342b, and 342c are mostly empty, and are thus lightly-used segments. A segment cleaning process may target these live blocks for moving to a free segment. Segment 344 is indicated as a heavily-used segment, and thus may be passed over for segment cleaning.

Returning now to FIG. 2, although local SUT 330a is illustrated as being stored within compute node, in some examples, local SUT 330a may be held elsewhere. In some examples, master SUT 330b is managed by a single node in the cluster (e.g., compute node 123, the master SUT owner), whose job is handing out free segments to all writers. Allocation of free segments to writers is indicated in master SUT 330b, with each writer being allocated different free segments, for example based on whether it is a local or global object. Master SUT 330b has some segments allocated for local storage (e.g., segment 338a), and allocates other segments for global storage (e.g., segment 338b). For example, when object 101 needs more segments, master SUT 330b finds new segments (e.g., free segment 338) and assigns it to object 101. Different writers receive different, non-overlapping assignments of free segments. Because each writer knows where to write, and writes to different free segments, all writers may operate in parallel.

Object map 361 is used for tracking the location of data, for example if some of incoming data 201 is stored in log 360 in performance tier 144. In some examples, object map 362 provides a similar function for incoming data 202. In some examples, all data coalesced by local object manager 204 (coalesced incoming data 232) is tracked in a single object map, for example object map 361. Other metadata 366 is also stored in performance tier 144, and data in performance tier 144 may be mirrored with mirror 364. When data from log 360, which had earlier been incoming data 201 and 201, is moved to data 368 in capacity tier 146, for example as part of a write of a full segment, references to incoming data 201 and 202 may be removed from object map 361. In some examples, object map 362 comprises a B-tree or a log-structured merge-tree (LSM tree), or some other indexing structure such as write-optimized tree, B^{ε}-tree. A B-tree is a self-balancing tree data structure that maintains sorted data and allows searches, sequential access, insertions, and deletions in logarithmic time. An LSM tree, or B^{ε}-tree, is a data structure with performance characteristics that make it attractive for providing indexed access to files with high insert volume, such as reference counts of data hash values. Each writer has its own object map. A logical-to-physical storage map 208 uses an object identifier (object ID) as a major key, thereby preventing overlap of the object maps of different writers.

When object 101 moves from compute node 121 to compute node 122, it becomes moved object 101a. Log 360 is replayed, at least the portion pertaining to object 101, to reconstruct object map 361 as a new object map 361a for the new node. In some examples, object map 361 is stored on compute node 121 and new object map 361a is stored on compute node 122. In some examples, object map 361 and new object map 361a are stored on performance tier 144 or elsewhere.

A local maintenance process 210a on compute nodes 121 and 122 (and also possibly on compute node 123) may be a local deduplication process and/or a local segment cleaning process. In some examples, a local segment cleaning process performs segment cleaning on local storage segments only, not global storage segments. A global maintenance process 210b on compute node 123 may be a global deduplication process and/or a global segment cleaning process. In some examples, a global deduplication process performs deduplication for global attribute data only, not for local attribute data. A hash table 214 is used by a deduplication process, whether local or global.

FIG. 3C illustrates exemplary messaging 350 among various components of FIGS. 1 and 2. Objects 101 and 102 (plus other writers) write at least a full segment in message 351. Local object manager 204 receives incoming data 201 and 202 (as message 351) from objects 101 and 102 and coalesces it into coalesced incoming data 232. That is, on a first node (compute node 121), local object manager 204 receives incoming data from each of a plurality of objects (101 and 102) local to the first node and coalesces the received incoming data 201 and 202. Objects 101 and 102 are configured to simultaneously write to the multi-writer LFS 134. Local object manager 204 calculates a checksum or a hash of the blocks of coalesced incoming data 232 as message 352. Local object manager 204 determines whether coalesced incoming data 232 comprises at least a full segment of data, such as enough to fill free segment 338, as message 353.

Based at least on determining that coalesced incoming data 232 comprises at least a full segment of data, local object manager 204 writes at least a first portion of coalesced incoming data 232 as one or more full segments of data to a first storage of the multi-writer LFS (e.g., capacity tier 146, either local or global storage, as indicated by the data attribute) as message 354. That is, in some examples, writing data to the first storage comprises writing local attribute data to local storage segments for the first node and writing global attribute data to global storage segments. Local object manager 204 writes a remainder portion of the coalesced incoming data (the amount of coalesced incoming data 232 minus the portion written to the first storage) to a second storage (e.g., performance tier 144) as message 355, and updates object map 361. That is, based at least on writing incoming data 201 and 202 to log 360, local object manager 204 updates at least object map 361 to indicate the writing of incoming data 201 to log 360. Log 360 and other metadata 366 are mirrored on performance tier 144. In some examples, updating object map 362 comprises mirroring metadata for object map 362. In some examples, mirroring metadata for object map 362 comprises mirroring metadata for object map 362 on performance tier 144. In some examples, mirroring metadata for object map 362 comprises using a three-way mirror. An acknowledgement 356, acknowledging the completion of the write (to log 360), is sent to objects 101 and 102.

Local object manager 204 determines whether log 360 has accumulated a full segment of data, such as enough to fill free segment 338, as message 357. Based at least on determining that log 360 has accumulated a full segment of data, local object manager 204 writes at least a portion of the accumulated data in log 360 (in the second storage, performance tier 144) as one or more full segments of data to the first storage (capacity tier 146), as message 358. In some examples, data can be first compressed before being written. Log 360 and object map 361 are purged of references to incoming data 202. This is accomplished by, based at least on writing the full segment of data, updating object map 362 to indicate the writing of the data.

FIG. 3D illustrates exemplary messaging 370 among various components of FIGS. 1 and 2. Local object manager 204 receives incoming data 201 and 202 from objects 101 and 102 and coalesces it into coalesced incoming data 232. Coalesced incoming data 232 comprises a full segment portion 372 (a first portion) and a remainder portion 374. Local object manager 204 writes at least the first portion (full segment portion 372) of coalesced incoming data 232 as one or more full segments of data to capacity tier 146 (a first storage). The data is written to either local global storage segments, based on whether objects 101 and 102 are local objects or global objects. Local object manager 204 writes remainder portion 374 of coalesced incoming data 232 to log 360 in performance tier 146 (a second storage). When at least a full segment 376 of data has accumulated in log 360 in the second storage (performance tier 146), it is written to the first storage (capacity tier 146). Full segment 376 will be written to either local or global storage in accordance with the attributes of objects 101 and 102.

FIG. 4 illustrates a flow chart 400 of a method of supporting distributed and local objects using a multi-writer LFS. In operation, each of objects 101-108 individually performs operations of flow chart 400, in parallel. Operation 402 includes monitoring, or waiting, for incoming data. For example, local object manager 204 waits for incoming data 201 and 202. Operation 404 includes, on a first node, receiving incoming data from each of a plurality of objects local to the first node (e.g., receiving incoming data 201 and 202 from objects 101 and 102, on compute node 121). The plurality of objects is configured to simultaneously write to the multi-writer LFS (e.g., LFS 134). In some examples, the object comprises a VM. In some examples, the object comprises a maintenance process, such as a deduplication process or a segment cleaning process. In some examples, the object comprises a virtualization layer. In some examples, the incoming data comprises an I/O (e.g., a write request).

Operation 406 includes coalescing the received incoming data. For example, incoming data 201 and 202 from objects 101 and 102 is coalesced into coalesced incoming data 232, as shown in FIG. 3D.

A decision operation 408 includes determining whether the coalesced incoming data comprises at least a full segment of data. In some examples, a segment size equals a stripe size. In some examples, a segment size equals an integer multiple of a stripe size. In some examples, a stripe size is 128 KB. In some scenarios, coalesced incoming data 232 may, by itself, comprise at least a full segment of data.

If so, operation 410 includes, based at least on determining that the coalesced incoming data comprises at least a full segment of data, writing at least a first portion of the coalesced incoming data as one or more full segments of data to a first storage of the multi-writer LFS. In some examples, the first storage comprises a capacity tier. In some examples, writing data to the first storage comprises writing local attribute data to the local storage segments for the first node and writing global attribute data to global storage segments. Operation 412 includes, based at least on writing data to the first storage, updating a local SUT to mark used segments as no longer free. In some examples, updating the local SUT comprises decreasing the number of available blocks indicated for the first segment. In some examples, updating the local SUT comprises increasing the number of live blocks indicated for the first segment. Remainder portion 374 of coalesced incoming data 232, which is not written as part of operation 410, in determined in operation 414.

Operation 416 includes writing the remainder portion of the coalesced incoming data to a second storage of the multi-writer LFS. In some examples, operation 416 includes, based at least on writing data to the first storage, updating a local segment usage table (SUT) to mark used segments as no longer free. For example, remainder portion 374 may be written to log 360 on performance tier 144. In some examples, the second storage comprises a performance tier. In some examples, writing the remainder portion to the second storage comprises writing the remainder portion to a log. In some examples, writing the remainder portion to the second storage comprises mirroring the remainder portion. In some examples, writing the remainder portion to the second storage comprises mirroring the remainder portion with a three-way mirror. Operation 418 includes, based at least on writing data to the second storage, updating an object map to indicate the writing of the data. For example, object map 361 may be updated as a result of writing remainder portion 374 to log 360 on performance tier 144. In some examples, a logical-to-physical storage map uses an object ID as a major key, thereby preventing overlap of object maps. In some examples, updating the object map comprises mirroring metadata for the object map. In some examples, mirroring metadata for the object map comprises using a three-way mirror. In some examples, the object map comprises an in-memory B-tree. In some examples, the object map comprises an LSM-tree. In some examples, the multi-writer LFS does not manage mirroring metadata. In some examples, a logical-to-physical storage map uses an object identifier as a major key, thereby preventing overlap of object maps.

Operation 420 includes acknowledging the writing to the plurality of objects. This way, for example, objects 101 and 102 do not need to wait for incoming data 201 and 202 to be written to capacity tier 146, but can be satisfied that the write is completed after incoming data 201 and 202 has been written to log 360. A decision operation 422 includes determining whether at least a full segment of data has accumulated in the second storage, for example in log 360. That is, log 360 may have accumulated enough data, from remainder portion 374, plus other I/Os, to fill free segment 338 and perhaps also free segment 338a. If not, flow chart 400 returns to waiting for more data, in operation 402. Otherwise, operation 424 includes, based at least on determining that at least a full segment of data has accumulated in the second storage, writing at least a portion of the accumulated data in the second storage as one or more full segments of data to the first storage. For example, data from log 360 is written as full segment 376 to free segment 338 of the set of free segments 338, 338a, and any other free segments allocated to object 101.

In some examples, operation 424 includes, based at least on at least writing the portion of the accumulated data to the first storage, updating the object map to indicate the writing of the portion of the accumulated data to the first storage. Operation 426 includes, based at least on writing at least the portion of the accumulated data to the first storage, updating the object map to indicate the writing of the portion of the accumulated data to the first storage. For example, references to incoming data 201 and 202 are removed from log 360. Operation 428 includes updating a local SUT to mark the first segment as no longer free. For example, object map 361 may be updated as a result of writing accumulated data from log 360 to free segment 338 on capacity tier 146. What had been free segment 338 is marked in local SUT 330a as now being a full segment. In some examples, updating the local SUT comprises increasing the number of live blocks indicated for the first segment. In some examples, updating the local SUT comprises decreasing the number of available blocks indicated for the first segment (e.g., to zero).

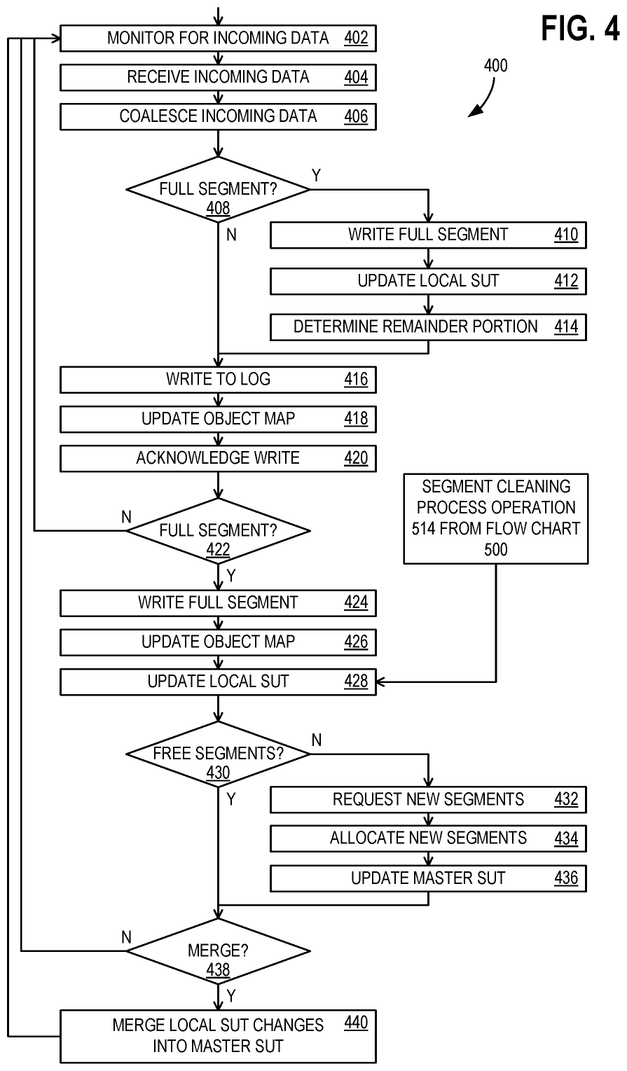

At this point, local changes are in-memory in dirty buffers. A dirty buffer is a buffer whose contents have been modified, but not yet written to disk. The contents may be written to disk in batches. A segment cleaning process, for example as performed by flow chart 500 of FIG. 5, indicates segments that had previously contained live blocks, but which were moved to new segments. In some examples, operation 428 includes based at least on performing a segment cleaning process, updating the local SUT to mark freed segments as free. In some examples, the merging of local SUT 330a into master SUT 330b (see operation 440, below) includes not only segments which have been written to (e.g., free segment 338, which is now occupied), but also segments that have been identified as free or now full according to a segment cleaning process.

A decision operation 430 includes determining whether sufficient free segments are available for writing the incoming data (e.g., coalesced incoming data 232), such as determining whether local object manager 204, or object 101 or 102 had been assigned free segment 338, and incoming data will not require any more space than free segment 338. If no free segments had been assigned, and at least one free segment is needed, then there is an insufficient number of free segments available. If one free segment had been assigned, and at least two free segments are needed, then there is an insufficient number of free segments available. In some examples, a reserve amount of free segments is maintained, and if the incoming data will drop the reserve below the reserve amount, then sufficient free segments are not available. If additional free segments are needed, operation 432 includes requesting allocation of new segments of the first storage. In some examples, requesting allocation of new segments comprises requesting allocation of new segments from the owner of the master SUT. In some examples, the request indicates a local or a global attribute.

Operation 434 includes allocating, by the owner of the master SUT, new segments, and operation 436 includes indicating the allocation of the new segments in the master SUT. So, for example, object 101 requests one or more new free segments from compute node 123, because compute node 123 is the master SUT owner. A process on compute node 123 allocates free segments 338 and 338a to object 101, and holds free segment 338b back for allocating to the next writer to request more free segments. The reservation of free segments 338 and 338a is indicated in master SUT 330b, for example by marking them as live. In this manner, allocation of new segments of the first storage is indicated in a master SUT.

A decision operation 438 includes determining whether a merge trigger condition has occurred. For example, a merge trigger may be a threshold amount of changes to local SUT 330a, which prompts a SUT merge into master SUT 330b. Merges may wait until a trigger condition, and are not needed immediately, because free segments had already been deconflicted. That is, each writer writes to only its own allocated segments. A conflict should not arise, at least until a wrap-around condition on the HDD. If there is no merge trigger condition, flow chart 400 returns to operation 402. Otherwise, operation 440 includes merging local SUT updates into the master SUT. In some examples, merging local SUT updates into the master SUT comprises, based at least on determining that the merge trigger condition has occurred, merging local SUT updates into the master SUT.

FIG. 5 illustrates a flow chart 500 of a segment cleaning process that may be used in conjunction with flow chart 400. A segment cleaning process is used to create free space, for example entire segments, for new writes. Aspects of the disclosure are able to perform multiple segment cleaning processes in parallel to free segments. In some examples, a segment cleaning process may operate for each local SUT. Segment cleaning processes may repeat upon multiple trigger conditions, such as a periodic time (e.g., every 30 seconds), when a compute node or object is idle, or when free space drops below a threshold. In some examples, the master SUT owner kicks off a segment cleaning process, spawning a logical segment cleaning worker that is a writer (object).

Operation 502 starts a segment cleaning process, and for some examples, if a segment cleaning process is started on each of multiple nodes (e.g., compute nodes 121 and 122), operation 502 comprises performing segment cleaning processes locally on each of a first node and a second node. Operation 504 identifies lightly used segments (e.g., segments 342a, 342b, and 342c), and these lightly used segments are read in operation 506. Operation 508 coalesces live blocks from a plurality of lightly used segments in an attempt to reach at least an entire segment's worth of data. Operation 510 writes the coalesced blocks back to storage, but using a fewer number of segments than the number of lightly used segments from which the blocks had been coalesced in operation 508.

Operation 512 includes notifying at least affected nodes of block movements resulting from the segment cleaning processes. For example, notification is delivered to operation 428 of flow chart 400. This enables local SUTs to be updated. Operation 514 includes updating the master SUT to indicate that the formerly lightly-used segments are now free segments, which can be assigned for further writing operations. In some examples, this occurs as part of operation 428 of flow chart 400. The segment cleaning process may then loop back to operation 504 or terminate.

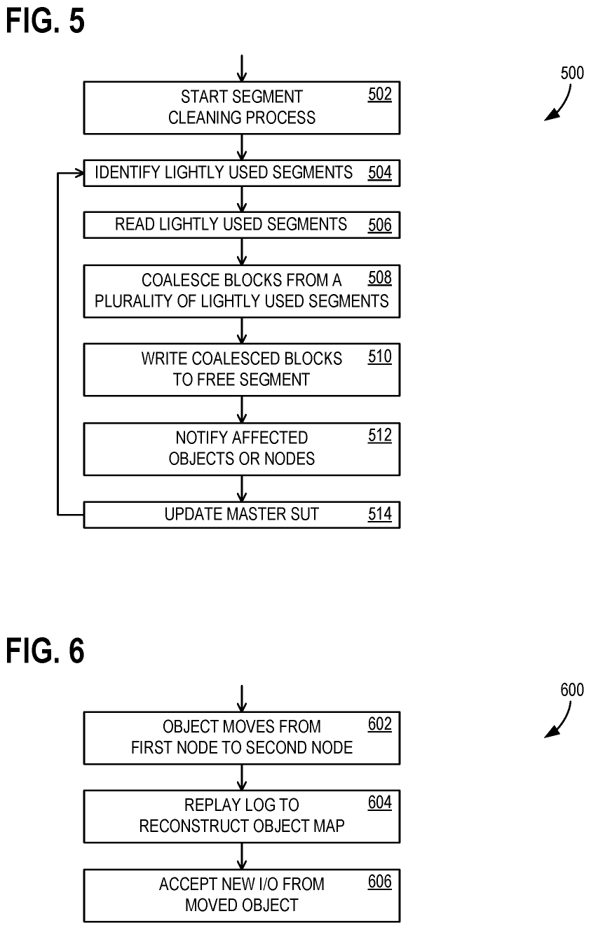

FIG. 6 illustrates a flow chart 600 of moving an object from a first compute node to a second (new) compute node, for example moving object 101 from compute node 121 to compute node 122. In operation 602 an object moves to a new compute node. Operation 604 includes, based at least on an object of the plurality of objects moving to a second node, prior to accepting new incoming data from the object, replaying the log to reconstruct a new object map. Operation 606 includes accept new incoming data from moved object. When an object (e.g., a VMDK) moves from one compute node to another compute node it first replays its part of the data log (e.g., log 360) from its original node to reconstruct the mapping table state for the new node before accepting new I/Os. In some examples, the operations of flow charts 400-600 are performed by one or more computing devices 800 of FIG. 8. Although flow charts 400-600 are illustrated for simplicity as a linear workflow, one or more of the operations represented by flow charts 400-600 may be asynchronous.

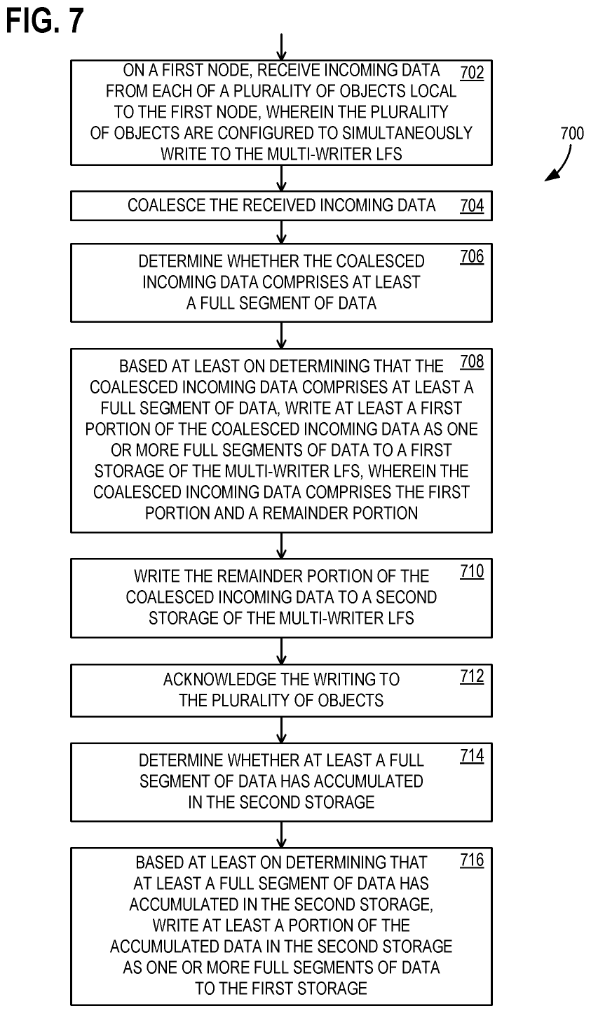

FIG. 7 illustrates a flow chart 700 showing a method of supporting distributed and local objects using a multi-writer LFS using a multi-writer LFS. In some examples, the operations of flow chart 700 are performed by one or more computing devices 800 of FIG. 8. Operation 702 includes, on a first node, receiving incoming data from each of a plurality of objects local to the first node, wherein the plurality of objects is configured to simultaneously write to the multi-writer LFS. In some examples, the object comprises a VM. Operation 704 includes coalescing the received incoming data. Operation 706 includes determining whether the coalesced incoming data comprises at least a full segment of data. Operation 708 includes, based at least on determining that the coalesced incoming data comprises at least a full segment of data, writing at least a first portion of the coalesced incoming data as one or more full segments of data to a first storage of the multi-writer LFS, wherein the coalesced incoming data comprises the first portion and a remainder portion. Operation 710 includes writing the remainder portion of the coalesced incoming data to a second storage of the multi-writer LF S. Operation 712 includes determining whether the log has accumulated a full segment of data. Operation 714 includes determining whether at least a full segment of data has accumulated in the second storage. Operation 716 includes based at least on determining that at least a full segment of data has accumulated in the second storage, writing at least a portion of the accumulated data in the second storage as one or more full segments of data to the first storage.

FIG. 8 illustrates a block diagram of computing device 800 that may be used within architecture 100 of FIG. 1. Computing device 800 has at least a processor 802 and a memory 804 (or memory area) that holds program code 810, data area 820, and other logic and storage 830. Memory 804 is any device allowing information, such as computer executable instructions and/or other data, to be stored and retrieved. For example, memory 804 may include one or more random access memory (RAM) modules, flash memory modules, hard disks, solid-state disks, NVMe devices, Persistent Memory devices, and/or optical disks. Program code 810 comprises computer executable instructions and computer executable components including any of virtual machine component 812, virtualization platform 130, virtual SAN component 132, local object manager 204, segment cleaning logic 814, and deduplication logic 816. Virtual machine component 812 generates and manages objects, for example objects 101-108. Segment cleaning logic 814 and/or deduplication logic 816 may represent various manifestations of maintenance processes 210a and 210b.

Data area 820 holds any of VMDK 822, incoming data 824, log 360, object map 826, local SUT 330a, master SUT 330b, storage map 208, and hash table 214. VMDK 822 represents any of VMDKs 111-118. Incoming data 824 represents any of incoming data 201 and 202. Object map 826 represents any of object maps 361 and 362. Memory 804 also includes other logic and storage 830 that performs or facilitates other functions disclosed herein or otherwise required of computing device 800. A keyboard 842 and a computer monitor 844 are illustrated as exemplary portions of I/O component 840, which may also or instead include a touchscreen, mouse, trackpad, and/or other I/O devices. A network interface 850 permits communication over a network 852 with a remote node 860, which may represent another implementation of computing device 800, a cloud service. For example, remote node 860 may represent any of compute nodes 121-123.

Computing device 800 generally represents any device executing instructions (e.g., as application programs, operating system functionality, or both) to implement the operations and functionality described herein. Computing device 800 may include any portable or non-portable device including a mobile telephone, laptop, tablet, computing pad, netbook, gaming device, portable medium player, desktop personal computer, kiosk, embedded device, and/or tabletop device. Additionally, computing device 800 may represent a group of processing units or other computing devices, such as in a cloud computing system or service. Processor 802 may include any quantity of processing units and may be programmed to execute any components of program code 810 comprising computer executable instructions for implementing aspects of the disclosure. In some embodiments, processor 802 is programmed to execute instructions such as those illustrated in the figures.

### ADDITIONAL EXAMPLES

An example computer system for supporting distributed and local objects using a multi-writer LFS comprises: a processor; and a non-transitory computer readable medium having stored thereon program code for transferring data to another computer system, the program code causing the processor to: on a first node, receive incoming data from each of a plurality of objects local to the first node, wherein the plurality of objects is configured to simultaneously write to the multi-writer LFS; coalesce the received incoming data; determine whether the coalesced incoming data comprises at least a full segment of data; based at least on determining that the coalesced incoming data comprises at least a full segment of data, write at least a first portion of the coalesced incoming data as one or more full segments of data to a first storage of the multi-writer LFS, wherein the coalesced incoming data comprises the first portion and a remainder portion; write the remainder portion of the coalesced incoming data to a second storage of the multi-writer LFS; acknowledge the writing to the plurality of objects; determine whether at least a full segment of data has accumulated in the second storage; and based at least on determining that at least a full segment of data has accumulated in the second storage, write at least a portion of the accumulated data in the second storage as one or more full segments of data to the first storage.

An example method of supporting distributed and local objects using a multi-writer LFS comprises: on a first node, receiving incoming data from each of a plurality of objects local to the first node, wherein the plurality of objects is configured to simultaneously write to the multi-writer LFS; coalescing the received incoming data; determining whether the coalesced incoming data comprises at least a full segment of data; based at least on determining that the coalesced incoming data comprises at least a full segment of data, writing at least a first portion of the coalesced incoming data as one or more full segments of data to a first storage of the multi-writer LFS, wherein the coalesced incoming data comprises the first portion and a remainder portion; writing the remainder portion of the coalesced incoming data to a second storage of the multi-writer LFS; acknowledging the writing to the plurality of objects; determining whether at least a full segment of data has accumulated in the second storage; and based at least on determining that at least a full segment of data has accumulated in the second storage, writing at least a portion of the accumulated data in the second storage as one or more full segments of data to the first storage.

An example non-transitory computer readable storage medium having stored thereon program code executable by a first computer system at a first site, the program code embodying a method comprises: on a first node, receiving incoming data from each of a plurality of objects local to the first node, wherein the plurality of objects is configured to simultaneously write to the multi-writer LFS; coalescing the received incoming data; determining whether the coalesced incoming data comprises at least a full segment of data; based at least on determining that the coalesced incoming data comprises at least a full segment of data, writing at least a first portion of the coalesced incoming data as one or more full segments of data to a first storage of the multi-writer LFS, wherein the coalesced incoming data comprises the first portion and a remainder portion; writing the remainder portion of the coalesced incoming data to a second storage of the multi-writer LFS; acknowledging the writing to the plurality of objects; determining whether at least a full segment of data has accumulated in the second storage; and based at least on determining that at least a full segment of data has accumulated in the second storage, writing at least a portion of the accumulated data in the second storage as one or more full segments of data to the first storage.

Alternatively, or in addition to the other examples described herein, examples include any combination of the following:
the object comprises a VM;
a segment size equals a stripe size;
a segment size equals an integer multiple of a stripe size;
a stripe size is 128 KB;
the first storage comprises a capacity tier;
writing data to the first storage comprises writing local attribute data to local storage segments for the first node and writing global attribute data to global storage segments;
based at least on writing data to the first storage, updating a local segment usage table (SUT) to mark used segments as no longer free; updating the local SUT comprises decreasing the number of available blocks indicated for the first segment;
updating the local SUT comprises increasing the number of live blocks indicated for the first segment;
writing the remainder portion to the second storage comprises writing the remainder portion to a log;
the second storage comprises a performance tier;
based at least on writing data to the second storage, updating an object map to indicate the writing of the data;
updating the object map comprises mirroring metadata for the object map;
mirroring metadata for the object map comprises using a three-way mirror;
the object map comprises an in-memory B-tree;
the object map comprises an LSM-tree;
a logical-to-physical storage map uses an object identifier as a major key, thereby preventing overlap of object maps;
based at least on at least writing the portion of the accumulated data to the first storage, updating the object map to indicate the writing of the portion of the accumulated data to the first storage;
writing the remainder portion to the second storage comprises mirroring the remainder portion;
writing the remainder portion to the second storage comprises mirroring the remainder portion with a three-way mirror;
determining whether sufficient free segments are available for writing the incoming data (e.g., the coalesced incoming data);
requesting allocation of new segments of the first storage;
requesting allocation of new segments comprises requesting allocation of new segments from the owner of the master SUT;
allocating, by an owner of a master SUT, new segments;
allocation of new segments of the first storage is indicated in the master SUT;
the request indicates a local or a global attribute;
determining whether a merge trigger condition has occurred;
merging local SUT updates into a master SUT;
merging local SUT updates into the master SUT comprises, based at least on determining that the merge trigger condition has occurred, merging local SUT updates into the master SUT;
based at least on an object of the plurality of objects moving to a second node, prior to accepting new incoming data from the object, replaying the log to reconstruct a new object map for the object on the second node, wherein the first node is a different physical node from the second node;
performing segment cleaning processes locally on each of the first node and a second node, the first node being a different physical node from the second node;
performing multiple segment cleaning processes in parallel to free segments;
based at least on performing a segment cleaning process, updating the local SUT to mark freed segments as free; and
notifying at least affected nodes of block movements resulting from the segment cleaning processes.

### Exemplary Operating Environment

The operations described herein may be performed by a computer or computing device. The computing devices comprise processors and computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible, non-transitory, and are mutually exclusive to communication media. In some examples, computer storage media are implemented in hardware. Exemplary computer storage media include hard disks, flash memory drives, NVMe devices, persistent memory devices, digital versatile discs (DVDs), compact discs (CDs), floppy disks, tape cassettes, and other solid-state memory. In contrast, communication media typically embody computer readable instructions, data structures, program modules, or other data in a modulated data signal such as a carrier wave or other transport mechanism, and include any information delivery media.

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of supporting distributed and local objects using a multi-writer log-structured file system (LFS), the method comprising:
on a first node, receiving incoming data from each of a plurality of objects local to the first node, wherein the plurality of objects is configured to simultaneously write to the multi-writer LFS;
coalescing the received incoming data;
determining whether the coalesced incoming data comprises at least a full segment of data;
based at least on determining that the coalesced incoming data comprises at least a full segment of data, writing at least a first portion of the coalesced incoming data as one or more full segments of data to a first storage of the multi-writer LFS, wherein the coalesced incoming data comprises the first portion and a remainder portion;
writing the remainder portion of the coalesced incoming data to a second storage of the multi-writer LFS;
acknowledging the writing to the plurality of objects;
determining whether at least a full segment of data has accumulated in the second storage; and
based at least on determining that at least a full segment of data has accumulated in the second storage, writing at least a portion of the accumulated data in the second storage as one or more full segments of data to the first storage.

2. The method of claim 1, further comprising:
requesting allocation of new segments of the first storage, wherein the request indicates a local or a global attribute.

3. The method of claim 1, further comprising:
performing segment cleaning processes locally on each of the first node and a second node, the first node being a different physical node from the second node.

4. The method of claim 1, further comprising:
based at least on writing data to the first storage, updating a local segment usage table (SUT) to mark used segments as no longer free;
based at least on performing a segment cleaning process, updating the local SUT to mark freed segments as free; and
merging local SUT updates into a master SUT.

5. The method of claim 1, wherein writing the remainder portion to the second storage comprises writing the remainder portion to a log; and
the method further comprises, based at least on an object of the plurality of objects moving to a second node, prior to accepting new incoming data from the object, replaying the log to reconstruct a new object map for the object on the second node, wherein the first node is a different physical node from the second node.

6. The method of claim 1, further comprising:
based at least on writing data to the second storage, updating an object map to indicate the writing of the data, wherein a logical-to-physical storage map uses an object identifier as a major key, thereby preventing overlap of object maps; and
based at least on at least writing the portion of the accumulated data to the first storage, updating the object map to indicate the writing of the portion of the accumulated data to the first storage.

7. The method of claim 1, wherein the first storage comprises a capacity tier, wherein the second storage comprises a performance tier, and wherein writing the remainder portion to the second storage comprises mirroring the remainder portion.

8. A computer system for supporting distributed and local objects using a multi-writer log-structured file system (LFS), the computer system comprising:
a processor; and
a non-transitory computer readable medium having stored thereon program code for transferring data to another computer system, the program code causing the processor to:
on a first node, receive incoming data from each of a plurality of objects local to the first node, wherein the plurality of objects is configured to simultaneously write to the multi-writer LFS;
coalesce the received incoming data;
determine whether the coalesced incoming data comprises at least a full segment of data;
based at least on determining that the coalesced incoming data comprises at least a full segment of data, write at least a first portion of the coalesced incoming data as one or more full segments of data to a first storage of the multi-writer LFS, wherein the coalesced incoming data comprises the first portion and a remainder portion;
write the remainder portion of the coalesced incoming data to a second storage of the multi-writer LFS;
acknowledge the writing to the plurality of objects;
determine whether at least a full segment of data has accumulated in the second storage; and
based at least on determining that at least a full segment of data has accumulated in the second storage, write at least a portion of the accumulated data in the second storage as one or more full segments of data to the first storage.

9. The computer system of claim 8, wherein the program code is further operative to:
request allocation of new segments of the first storage, wherein the request indicates a local or a global attribute.

10. The computer system of claim 8, wherein the program code is further operative to:
perform segment cleaning processes locally on each of the first node and a second node, the first node being a different physical node from the second node.

11. The computer system of claim 8, wherein the program code is further operative to:
based at least on writing data to the first storage, update a local segment usage table (SUT) to mark used segments as no longer free;
based at least on performing a segment cleaning process, update the local SUT to mark freed segments as free; and
merge local SUT updates into a master SUT.

12. The computer system of claim 8, wherein writing the remainder portion to the second storage comprises writing the remainder portion to a log; and
wherein the program code is further operative to, based at least on an object of the plurality of objects moving to a second node, prior to accepting new incoming data from the object, replay the log to reconstruct a new object map for the object on the second node, wherein the first node is a different physical node from the second node.

13. The computer system of claim 8, wherein the program code is further operative to:
based at least on writing data to the second storage, update an object map to indicate the writing of the data, wherein a logical-to-physical storage map uses an object identifier as a major key, thereby preventing overlap of object maps; and
based at least on at least writing the portion of the accumulated data to the first storage, update the object map to indicate the writing of the portion of the accumulated data to the first storage.

14. The computer system of claim 8, wherein the first storage comprises a capacity tier, wherein the second storage comprises a performance tier, and wherein writing the remainder portion to the second storage comprises mirroring the remainder portion.

15. A non-transitory computer readable storage medium having stored thereon program code executable by a first computer system at a first site, the program code embodying a method comprising:
on a first node, receiving incoming data from each of a plurality of objects local to the first node, wherein the plurality of objects is configured to simultaneously write to the multi-writer LFS;
coalescing the received incoming data;
determining whether the coalesced incoming data comprises at least a full segment of data;
based at least on determining that the coalesced incoming data comprises at least a full segment of data, writing at least a first portion of the coalesced incoming data as one or more full segments of data to a first storage of the multi-writer LFS, wherein the coalesced incoming data comprises the first portion and a remainder portion;
writing the remainder portion of the coalesced incoming data to a second storage of the multi-writer LFS;
acknowledging the writing to the plurality of objects;
determining whether at least a full segment of data has accumulated in the second storage; and
based at least on determining that at least a full segment of data has accumulated in the second storage, writing at least a portion of the accumulated data in the second storage as one or more full segments of data to the first storage.

16. The non-transitory computer storage medium of claim 15, wherein the program code further comprises:
requesting allocation of new segments of the first storage, wherein the request indicates a local or a global attribute.

17. The non-transitory computer storage medium of claim 15, wherein the program code further comprises:
performing segment cleaning processes locally on each of the first node and a second node, the first node being a different physical node from the second node.

18. The non-transitory computer storage medium of claim 15, wherein the program code further comprises:
based at least on writing data to the first storage, updating a local segment usage table (SUT) to mark used segments as no longer free;
based at least on performing a segment cleaning process, updating the local SUT to mark freed segments as free; and
merging local SUT updates into a master SUT.

19. The non-transitory computer storage medium of claim 15, wherein writing the remainder portion to the second storage comprises writing the remainder portion to a log; and
wherein the program code further comprises, based at least on an object of the plurality of objects moving to a second node, prior to accepting new incoming data from the object, replaying the log to reconstruct a new object map for the object on the second node, wherein the first node is a different physical node from the second node.

20. The non-transitory computer storage medium of claim 15, wherein the first storage comprises a capacity tier, wherein the second storage comprises a performance tier, and wherein writing the remainder portion to the second storage comprises mirroring the remainder portion.
